(19) United States
(12) Patent Application Publication
(10) Pub. No.: US 2016/0018541 A1
(43) Pub. Date: Jan. 21, 2016

(54) SYSTEM AND METHOD FOR ROCK PROPERTY ESTIMATION OF SUBSURFACE GEOLOGIC VOLUMES

(71) Applicant: Joseph Paul Stefani, San Francisco, CA (US)

(72) Inventor: Joseph Paul Stefani, San Francisco, CA (US)

(73) Assignee: Chevron U.S.A. Inc., San Ramon, CA (US)

(21) Appl. No.: 14/335,136

(22) Filed: Jul. 18, 2014

(51) Int. Cl. G01V 1/28; G01V 1/32

(52) U.S. Cl. CPC G01V 1/282; G01V 1/32

(57) ABSTRACT

A system and model for estimating rock properties may include receiving an initial reservoir model of the subsurface, calculating p-dependent reflection coefficients and vertical travel times at each boundary in the initial reservoir model, performing a Discrete Fourier Transform using the reflection coefficients and travel times to get a temporal spectrum of the reflectivity trace, multiplying by the temporal spectrum of a desired wavelet, performing an inverse DFT, and extracting the amplitude values at the vertical travel times for each boundary to generate synthetic seismic data. This synthetic seismic data may be compared with recorded seismic data to update the reservoir model.

### FIELD OF THE INVENTION

The present invention relates generally to methods and systems for estimating rock properties of subsurface geologic volumes of interest by modeling seismic data and, in particular, methods and systems for accurately modeling synthetic seismic data to be compared with recorded seismic data to estimate rock properties.

### BACKGROUND OF THE INVENTION

In the field of exploration geophysics, seismic data is typically recorded through the use of active seismic sources, such as air guns, vibrator units, or explosives, and receivers, such as hydrophones or geophones. The sources and receivers may be arranged in many configurations. Typically, a seismic survey is designed to optimize the source and receiver configurations so that the recorded seismic data may be processed to locate and/or analyze subsurface geological features of interest such as hydrocarbon reservoirs.

Recorded seismic data is useful for identifying structural features of the subsurface but in many instances it is desirable to estimate rock properties, such as density, seismic velocities, anisotropy, etc. Methods exist that attempt to invert recorded seismic data to estimate rock properties but these methods are computationally expensive and require a large amount of expertise to use reliably. Some methods use an initial reservoir model with initial estimates of the rock properties to create synthetic seismic data by forward modeling wave propagation through the reservoir model and storing the simulated recordings, which are traces indicating amplitude and traveltime of simulated events (e.g. reflections) as recorded at simulated receivers. The synthetic seismic data can then be compared to the recorded seismic data to determine how accurate the reservoir model is and how to update the reservoir model. However, these methods are fraught with problems such as inaccurate wave propagation, modeling artifacts, and errors in interpolation between the travel-time-domain of the seismic data and the depth-domain of the reservoir model.

There is a need for seismic modeling methods that are computationally efficient and can improve estimation of parameters such as, by way of example and not limitation, subsurface velocities, density, anisotropy parameters, and attenuation, thereby improving the estimation of the rock properties in the reservoir model of the subsurface so that hydrocarbon reservoirs may be identified and produced in an efficient and economical way.

### SUMMARY OF THE INVENTION

Described herein are implementations of various approaches for a computer-implemented method for seismic modeling of a subsurface volume of interest.

A computer-implemented method for modeling seismic data may include receiving an initial reservoir model of the subsurface, calculating p-dependent reflection coefficients and vertical travel times at each boundary in the initial reservoir model, performing a Discrete Fourier Transform using the reflection coefficients and travel times to get a temporal spectrum of the reflectivities, multiplying the temporal spectrum of the reflectivities by the temporal spectrum of a desired wavelet, performing an inverse DFT, and extracting the amplitude values at the vertical travel times for each boundary to generate synthetic seismic data. This synthetic seismic data may be compared with recorded seismic data to update the reservoir model.

In another embodiment, a computer system including a data source or storage device, at least one computer processor, and a user interface used to implement the method for seismic modeling of a subsurface volume of interest is disclosed.

In yet another embodiment, an article of manufacture including a non-transitory computer readable medium having computer readable code on it, the computer readable code being configured to implement a method for seismic modeling of a subsurface volume of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a diagram of the relationship between a reservoir model and seismic data;

FIG. 2 is a flowchart of an embodiment of the present invention;

FIG. 3 illustrates an example of a reservoir model;

FIG. 4 illustrates a single surface location from a reservoir model with its associated cells along the depth axis and the reflectivity series calculated from the reservoir properties in the cells;

FIG. 5 illustrates an example of synthetic seismic data modeled by the present invention; and

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms, environments, and architectures. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

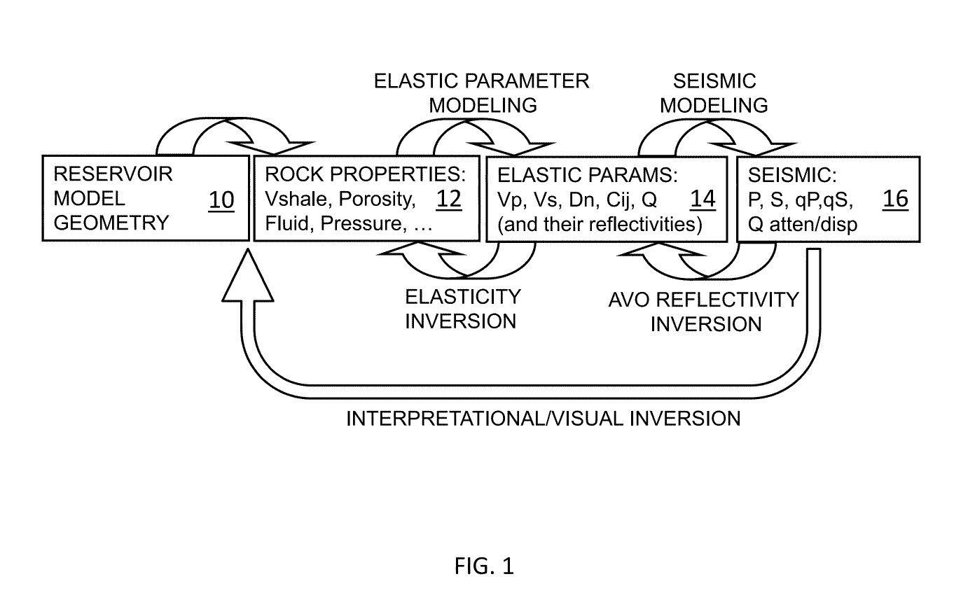

The present invention relates to estimating rock properties of subsurface geologic volumes of interest by modeling (i.e. generating by forward modeling) synthetic seismic data to be compared with recorded seismic data, as illustrated by FIG. 1. In FIG. 1, the reservoir model geometry 10 contains information about the structure (e.g. rock layers, formations, etc.) of the subsurface. The rock properties 12 are assigned to the cells of the reservoir model geometry 10; the rock properties 12 may be used to calculate elastic parameters 14 by elastic parameter modeling. Elastic parameters 14 can be used in seismic modeling to form the synthetic seismic dataset 16. The synthetic seismic dataset 16 can be used in an interpretational/visual inversion to update the reservoir model geometry 10 and/or the rock properties 12. This loop is also applicable in the reverse: given a recorded or synthetic seismic dataset 16, an AVO reflectivity inversion can be used to calculate the elastic parameters 14. The elastic parameters 14 can be used as input to an elasticity inversion to find the rock properties 12. One skilled in the art will know of methods to perform the various modeling and inversion operations. The present invention provides a new, better way to perform seismic modeling with fewer artifacts and lower computational cost than conventional methods.

A conventional method for modeling synthetic seismic data may be propagating a wavefront through a reservoir model and measuring the seismic amplitudes at receiver locations specified by the user. Another conventional method might convolve a seismic wavelet with a reflectivity series representing a reservoir model. In both of these, the synthetic seismic data is created in the travel-time-domain, meaning that a particular seismic trace or record has a time dimension or axis. However, reservoir models are generally created in the depth-domain, meaning that the reservoir model has a depth dimension or axis. Typically, the sampling rate along the depth dimension of a reservoir model is too coarse for good quality synthetic data modeling using these conventional methods. A known method for handling this problem is to increase the sampling rate along the depth dimension of the reservoir model, which improves the accuracy of the synthetic seismic data modeling but at a greater computational cost and requires the storage of a second, often very large, independent reservoir model in computer memory. This is a source of workflow blockage and loss of efficiency for the conventional methods. The present invention eliminates this by remaining in the natural depth domain of the reservoir model throughout, thereby rendering unnecessary the excursions between time and depth domains and the need for a second independent reservoir model with fine sampling along the depth axis.

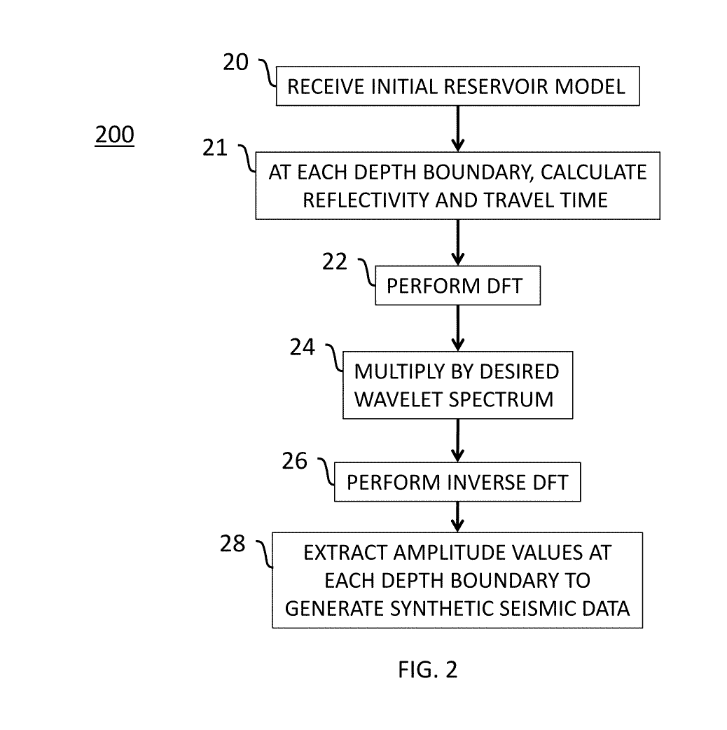

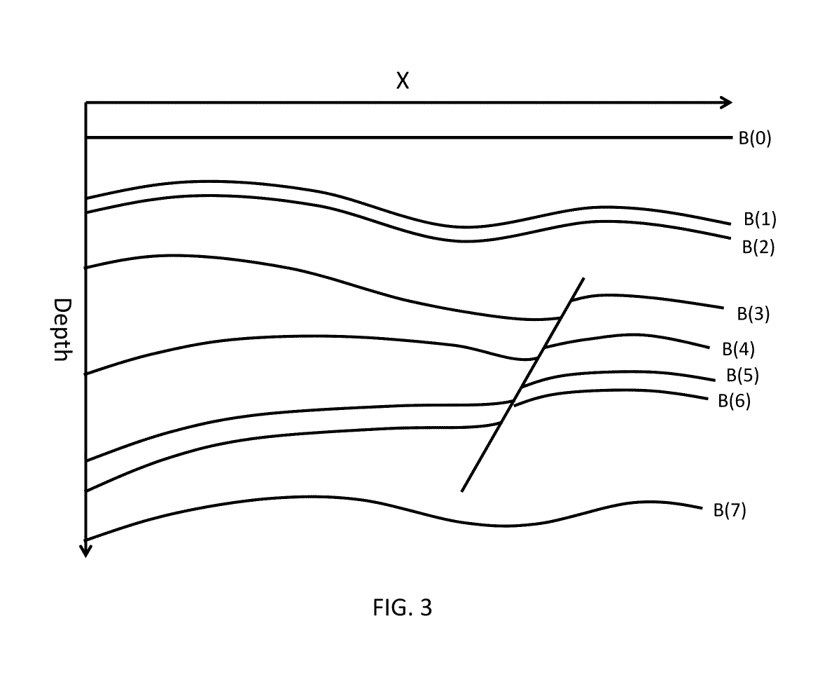

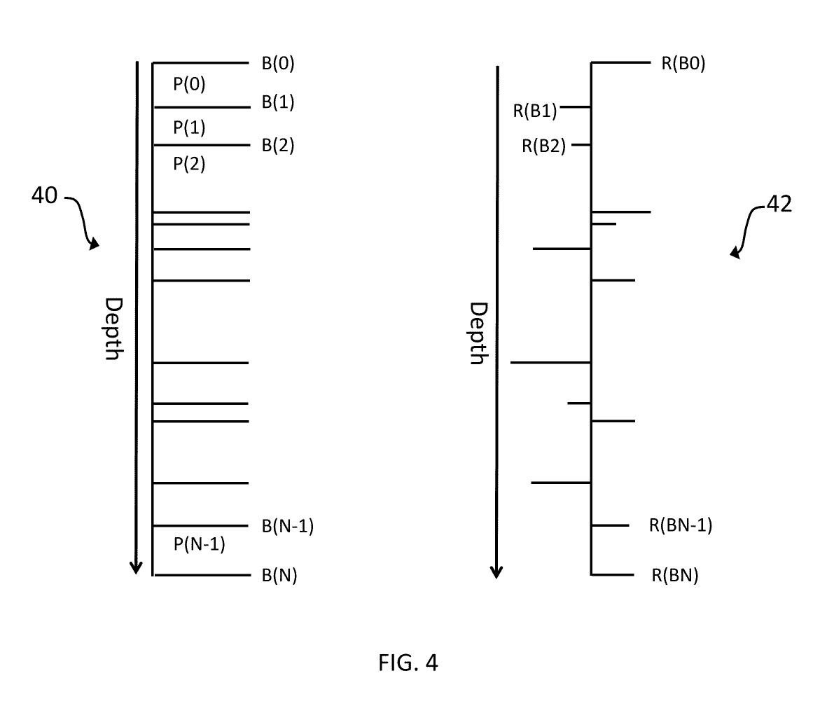

One embodiment of the present invention is shown as method 200 in FIG. 2. At operation 20, an initial reservoir model is received. The initial reservoir model will include at least a compressional velocity parameter and a density parameter for a plurality of subsurface locations. In addition, the reservoir model may include other parameters such as, but not limited to, shear velocity parameters, anisotropy parameters and attenuation parameters. The reservoir model may be 1-D, 2-D, or 3-D and must have a depth axis, such as the diagram in FIG. 3. Each surface location, which is located along the X axis (or X and Y axis for a 3-D reservoir model), has a plurality of subsurface cells along the depth axis which are separated by boundaries such as the boundaries B(0) through B(7) in FIG. 3. The model in FIG. 3 is an example of a simple model; reservoir models many include any number of boundaries (N boundaries). FIG. 4 has an example of the subsurface cells 40 for a single surface location. The set of subsurface cells 40 are separated by boundaries B(0)-B(N) which occur at known depths. Each cell contains at least one reservoir property, shown as P(0)-P(N−1) in FIG. 4. These reservoir properties may be rock properties such as shale volume, porosity, fluid content, and the like as well as elastic properties such as compressional velocity Vₚ, shear velocity Vₛ, density ρ, anisotropy parameters, attenuation parameters, and the like. Some of the reservoir properties may be derived from other properties, as illustrated by FIG. 1. In the context of FIG. 1, the initial reservoir model of method 200 is the model containing the elastic parameters 44, which may be obtained by elastic parameter modeling of the rock properties 42 in the context of the reservoir model geometry 40.

Referring again to FIG. 2, after the initial reservoir model has been received, the two-way vertical travel time and reflectivity are calculated at each boundary (operation 21). The two-way vertical travel times are calculated from the thicknesses (calculated from the depths) and Vₚ of the cells above the boundary and assume a constant ray parameter p. The constant value of the ray parameter p throughout the entire depth interval is equal to the trigonometric sine of the incidence angle of the incident wave above the stack of layers, divided by the average compressional velocity above the stack of layers. The travel times to a particular boundary are equal for all values of p, which produces a synthetic gather of traces all referenced to the vertical travel time (i.e., normal moveout is absent). In this paper, the terms reflection coefficient and reflectivity are used interchangeably. The reflectivity trace 42 is illustrated in FIG. 4 with reflection coefficents R(B0)-R(BN). The reflectivity for a plurality of incidence angles θ may be calculated, for example, using a form of the Zoeppritz equation such as the 3-term Shuey equation:

$$R ( θ ) = R ( 0 ) + G {sin}^{2} ( θ ) + F ( {tan}^{2} ( θ ) - {sin}^{2} ( θ ) )$$

$$where$$

$$R ( 0 ) = \frac{1}{2} ( \frac{Δ {V}_{p}}{{V}_{p}} + \frac{Δρ}{ρ} )$$

$$G = \frac{1}{2} \frac{Δ {V}_{p}}{{V}_{p}} - 2 \frac{{V}_{s}^{2}}{{V}_{p}^{2}} ( \frac{Δρ}{ρ} + 2 \frac{Δ {V}_{s}}{{V}_{s}} )$$

$$F = \frac{1}{2} \frac{Δ {V}_{p}}{{V}_{p}} .$$

and where θ=arcsin(p*Vₚ).

Those skilled in the art will understand that there are other ways to calculate the reflectivity coefficients, including other approximations to the Zoeppritz equation, as well as the exact form of the Zoeppritz coefficients.

Once the two-way travel time and reflection coefficients are calculated for each boundary and the depth of each boundary is noted, method 200 continues on to operation 22 where a Discrete Fourier Transform (DFT) is performed using the reflection coefficients and the non-uniformly spaced travel times associated with each boundary to generate a temporal spectrum of reflectivity. Conventional seismic processing often uses Fast Fourier Transforms (FFTs) but does not use the DFT because it is more computationally expensive. The DFT is used by the present invention because it can handle the non-uniformly spaced travel times; the present invention does not suffer greatly from the increased computational cost of the DFT due to the advantage of performing it only for the N travel times calculated for the reservoir model.

At operation 24, the temporal spectrum of reflectivity is multiplied with a temporal spectrum of a desired seismic wavelet. The desired seismic wavelet can be selected by the user and/or determined from a recorded seismic dataset. By way of example and not limitation, the wavelet may be user-supplied, a spike, a Ricker wavelet, or a Butterworth wavelet and may additionally have a time delay and/or phase shift. The wavelet may be received in the time domain and be transformed into its temporal spectrum using, for example, a FFT. The multiplication of operation 24 in the frequency domain produces the temporal spectrum of a time trace representing the wavelet convolved with the reflectivity trace in the time domain.

At operation 26, an inverse DFT is applied to the temporal spectrum of the time trace; only the amplitude values for the specific travel times associated with each boundary, those travel times found at operation 21, are extracted. These amplitude values are assigned to the depth location of the relevant boundaries. This produces a trace of synthetic seismic data in the depth domain with no need for interpolation.

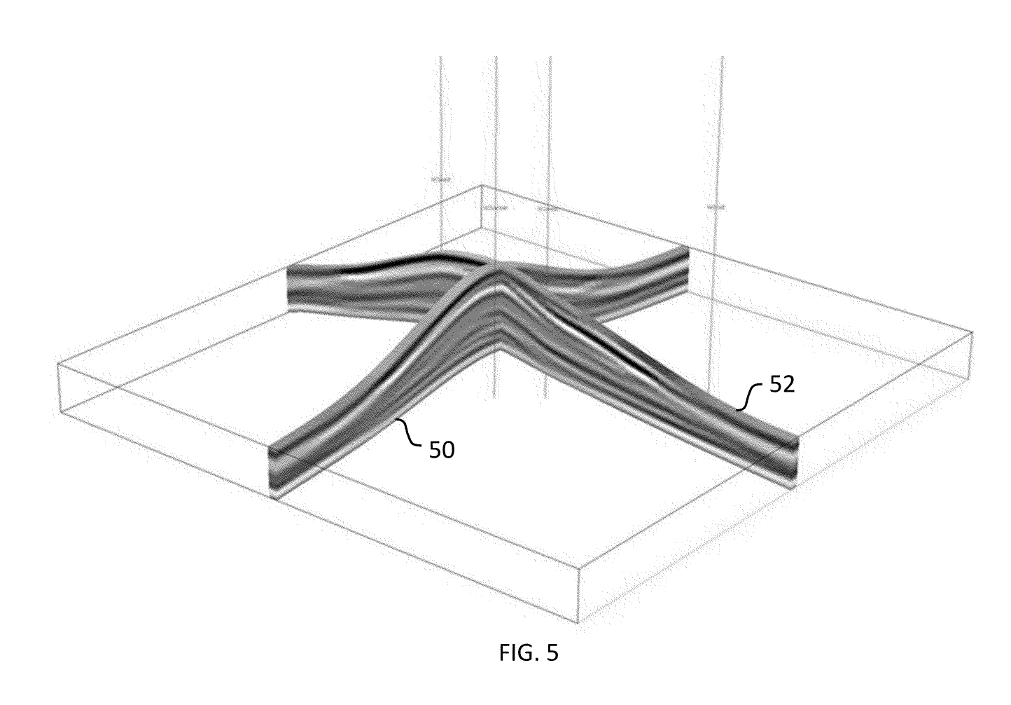

The synthetic seismic data traces can be found for a plurality of incidence angles by calculating the varying reflectivity at operation 21, thereby generating an angle gather of synthetic seismic data. If desired, this process can be repeated for a plurality of surface locations in the initial reservoir model, generating a synthetic seismic dataset. An example of synthetic seismic data generated according to an embodiment of the present invention may be seen in FIG. 5. This shows two intersecting cross-sections 50 and 52 of the synthetic seismic data volume.

The synthetic seismic dataset can be compared to a recorded seismic dataset in order to assess the accuracy of the initial reservoir model and update it accordingly, as indicated in FIG. 1 as the interpretational/visual inversion. The updated reservoir model can then proceed through method 200 to generate an updated synthetic dataset, which can be compared with both the first synthetic dataset and a recorded seismic dataset. Iterations over these loops can continue until the user is satisfied.

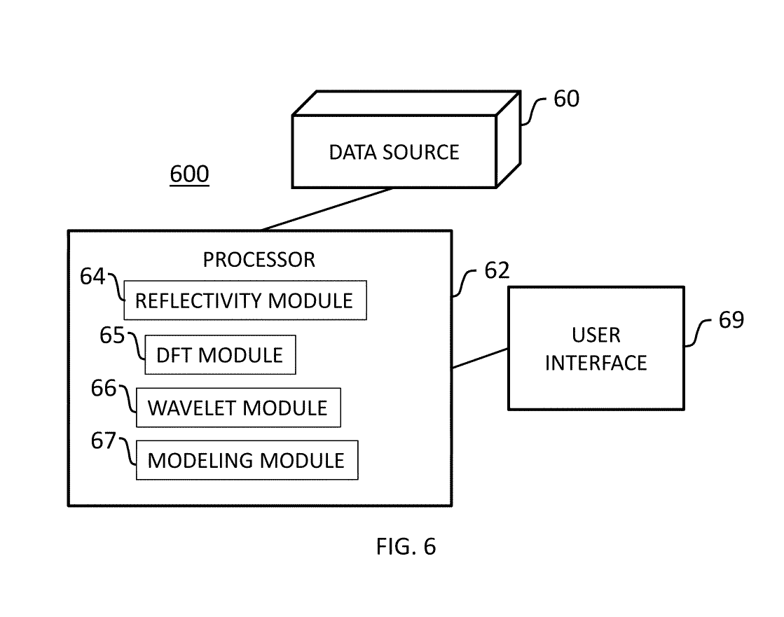

A system 600 for performing the method 200 of FIG. 2 is schematically illustrated in FIG. 6. The system includes a data source/storage device 60 which may include, among others, a data storage device or computer memory. The data source/storage device 60 may contain an initial reservoir model, recorded seismic data and/or synthetic seismic data. The data from data source/storage device 60 may be made available to a processor 62, such as a programmable general purpose computer. The processor 62 is configured to execute computer modules that implement method 200. These computer modules may include a reflectivity module 64 for calculating the reflection coefficients and the travel times at the boundaries of the reservoir model, a DFT module 65 to perform a DFT on the reflectivity trace and an inverse DFT on the temporal spectrum of the time trace, a wavelet module 66 for multiplying the temporal spectrum of the reflectivity trace with the temporal spectrum of a desired wavelet, and a modeling module 67 for extracting the amplitude values at the travel times associated with the boundaries of the reservoir model, thereby generating the synthetic seismic data. These modules may include other functionality. In addition, other modules such as an inversion module to invert the synthetic seismic data may be used. The system may include interface components such as user interface 69. The user interface 69 may be used both to display data and processed data products and to allow the user to select among options for implementing aspects of the method. By way of example and not limitation, the reservoir model and/or the synthetic seismic data computed on the processor 62 may be displayed on the user interface 69, stored on the data storage device or memory 60, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for modeling seismic data, the method comprising:
a. receiving, at a computer processor, an initial geologic model of the subsurface volume of interest, wherein the initial geologic model contains a plurality of surface locations, each surface location being associated with a sequence of cells along a depth axis, wherein each cell contains values of one or more reservoir properties;
b. calculating, via the computer processor, p-dependent reflection coefficients at each boundary in the sequence of cells;
c. calculating, via the computer processor, vertical travel times at each boundary in the sequence of cells;
d. calculating, via the computer processor, a Discrete Fourier Transform (DFT) at each boundary in the sequence of cell using the p-dependent reflection coefficients and the vertical travel times associated with each boundary to generate a temporal spectrum of reflectivity;
e. determining a temporal spectrum of a desired seismic wavelet;
f. calculating a temporal spectrum of a time trace by multiplying the temporal spectrum of reflectivity and the temporal spectrum of the desired seismic wavelet;
g. performing an inverse Discrete Fourier Transform (DFT) on the temporal spectrum of the time trace;
h. extracting amplitude values for the vertical travel times at each boundary; and
i. generating a modeled seismic dataset with the depth axis by assigning the amplitude values to a depth location of each boundary.

2. The method of claim 1 wherein the sequence of cells along the depth axis have non-uniform thicknesses.

3. The method of claim 1 further comprising receiving a recorded seismic dataset.

4. The method of claim 3 wherein the desired seismic wavelet is determined from the recorded seismic dataset.

5. The method of claim 1 further comprising determining an updated reservoir by comparing the modeled seismic dataset and the recorded seismic dataset.

6. The method of claim 1 wherein the p-dependent reflection coefficients are calculated for a plurality of incidence angles.

7. A system for modeling seismic data, the system comprising:
a. a data source containing an initial reservoir model;
b. a computer processor configured to execute computer modules, the computer modules comprising:
i. a reflectivity module for calculating p-dependent reflection coefficients and vertical travel times at each boundary in the initial reservoir model;
ii. a Discrete Fourier Transform (DFT) module for performing a DFT using the p-dependent reflection coefficients and the vertical travel times and for performing an inverse DFT;
iii. a wavelet module for multiplying temporal spectra; and
iv. a modeling module for extracting amplitudes from an inverse DFT at the vertical travel times to generate synthetic seismic data; and
c. a user interface.

8. The system of claim 7 wherein the data source also contains a recorded seismic dataset and further comprising an inversion module for updating the initial reservoir model by comparing the synthetic seismic data and the recorded seismic dataset.

9. An article of manufacture including a non-transitory computer readable medium having computer readable code on it, the computer readable code being configured to implement a method for modeling seismic data, the method comprising:
a. receiving an initial geologic model of the subsurface volume of interest, wherein the initial geologic model contains a plurality of surface locations, each surface location being associated with a sequence of cells along a depth axis, wherein each cell contains values of one or more reservoir properties;
b. calculating p-dependent reflection coefficients at each boundary in the sequence of cells;
c. calculating vertical travel times at each boundary in the sequence of cells;
d. calculating a Discrete Fourier Transform (DFT) at each boundary in the sequence of cell using the p-dependent reflection coefficients and the vertical travel times associated with each boundary to generate a temporal spectrum of reflectivity;
e. determining a temporal spectrum of a desired seismic wavelet;
f. calculating a temporal spectrum of a time trace by multiplying the temporal spectrum of reflectivity and the temporal spectrum of the desired seismic wavelet;
g. performing an inverse Discrete Fourier Transform (DFT) on the temporal spectrum of the time trace;
h. extracting amplitude values for the vertical travel times at each boundary; and
i. generating a modeled seismic dataset with the depth axis by assigning the amplitude values to a depth location of each boundary.
